(19) United States
(12) Patent Application Publication
(10) Pub. No.: US 2008/0173163 A1
(43) Pub. Date: Jul. 24, 2008

(54) MUSICAL INSTRUMENT INPUT DEVICE

(76) Inventor: Jonathan E. Pratt, Lilburn, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 12/018,264

(22) Filed: Jan. 23, 2008

Related U.S. Application Data
(60) Provisional application No. 60/897,101, filed on Jan. 24, 2007.

(51) Int. Cl. G10H 7/00; G10C 3/12

(52) U.S. Cl. 84/645; 84/423 R

(57) ABSTRACT

A musical instrument input device includes a frame having a latitudinal top surface and an array of equally sized and spaced apart keys mounted onto the latitudinal top surface. Each of the keys corresponds to a note on a chromatic scale and each of the keys is arranged in a plurality of rows and a plurality of columns. The keys in each row are arranged to correspond to a chromatic scale and the keys in any selected row are in a scalar transposition by a predetermined interval relative to each row adjacent to the selected row so that each key in a column corresponds to a note that is shifted from a note corresponding to an immediately adjacent key in the column by the predetermined interval. A note generator generates a sound corresponding to a note associated with a selected key when the selected key is activated.

### CROSS-REFERENCE TO RELATED APPLICATION(S)

This application claims the benefit of U.S. Provisional Patent Application Ser. No. 60/897,101, filed Jan. 24, 2007, the entirety of which is hereby incorporated herein by reference.

### BACKGROUND OF THE INVENTION

1. Field of the Invention

The present invention relates to musical instruments and, more specifically, to an instrument in which keys are laid out in transposed scales.

2. Description of the Prior Art

Musical instruments have been found in every civilization since the dawn of mankind. Most musical instruments play a variety of different notes that are organized according to a scale. Scales in traditional Western music generally consist of seven full notes that repeat at the octave. Five half-note steps are included with most instruments, giving the scale 12 musical steps. The chromatic scale is a musical scale with twelve pitches, each a semitone or half step apart.

A musical scale is a group of successive musical notes in which the notes are ordered in pitch, with their ordering providing a measure of musical distance. A scale step is the distance between two successive notes in a scale. A scale may be transposed by moving every note in a work by a fixed musical distance. For example, in the current Western standard 12-step scale, if a work is transposed by five scale steps, then every occurrence of the note “A” is changed to “D,” every occurrence of “A-sharp” is changed to “D-sharp,” every occurrence of “B” is changed to “E,” and so on.

Musicians transpose scales for several reasons. For example, a musician may transpose an entire work to adapt the work to the optimal range of a vocalist. In a single work, a portion of the work may be transposed to give a desired musical effect.

The piano is a musical instrument that includes a keyboard through which a musician generates notes. The piano is widely used in many types of music, from classical to jazz, both solo and accompanied by other instruments and vocalists. The piano keyboard provides the model for other types of keyboards, including the accordion keyboard and electronic keyboards. The piano keyboard employs a chromatic scale in which whole notes (A-B-C-D-E-F-G) are represented by white keys and half notes (A#-C#-D#-F#-G#) are represented by raised black keys.

Musical transposition employing an interval of anything less than a full octave is conceptually difficult with a piano keyboard. This is because several of the whole-note steps of a transposed scale will fall on half-note keys, For example, transposing the A-B-C-D-E-F-G scale up by one note will result in the musician having to play the following notes to achieve the same relationship between the notes: B-C#-D-E-F#-G-A. Because the relative finger movements are different between an original scale and a transposed scale, transposing scales on a piano keyboard can be conceptually difficult.

Certain types of instruments lend themselves readily to transposing scales. For example, stringed instruments (such as violins, cellos, bases and guitars, etc.) include several different strings wherein each adjacent string is tuned to a note that is a predetermined interval away from the string immediately adjacent to it. Therefore, one can transpose a scale played on a first string simply by applying the same finger positions used on the first string to an adjacent string. For this reason, a musician familiar with one stringed instrument will have a relatively easy time learning how to play another stringed instrument, but will have a relatively difficult time learning to play an instrument that employs a piano keyboard.

Therefore, there is a need for a keyboard-type instrument that allows for easy transposition of a scale.

### SUMMARY OF THE INVENTION

The disadvantages of the prior art are overcome by the present invention which, in one aspect, is a musical instrument input device that includes a frame having a latitudinal top surface and an array of equally sized and spaced apart keys mounted onto the latitudinal top surface. Each of the keys corresponds to a note on a chromatic scale and each of the keys is arranged in a plurality of rows and a plurality of columns. The keys in each row are arranged to correspond to a chromatic scale and the keys in any selected row are in a scalar transposition by a predetermined interval relative to each row adjacent to the selected row so that each key in a column corresponds to a note that is shifted from a note corresponding to an immediately adjacent key in the column by the predetermined interval. A note generator generates a sound corresponding to a note associated with a selected key when the selected key is activated.

In another aspect, the invention is an electronic musical instrument that includes a frame having a latitudinal top surface and an array of equally sized and spaced apart keys mounted onto the latitudinal top surface. Each of the keys corresponds to a note on a chromatic scale and each of the keys is arranged in a plurality of rows and a plurality of columns. The keys in each row are arranged to correspond to a chromatic scale and the keys in any selected row are in a scalar transposition by a predetermined interval relative to each row adjacent to the selected row so that each key in a column corresponds to a note that is shifted from a note corresponding to an immediately adjacent key in the column by the predetermined interval. A plurality of spring-loaded switches are each coupled to a different key of the array of equally sized and spaced apart keys. A musical instrument digital interface processor receives input from each of the spring-loaded switches and generates a digital message onto a digital message output of a musical instrument digital interface when a selected switch of the array is depressed so that the digital message corresponds to a note associated with the selected switch. A sound generating system is coupled to the digital message output and generates a sound corresponding to a digital message received from the musical instrument digital interface processor.

In yet another aspect, the invention is an electronic musical keyboard that includes a frame having a latitudinal top surface. An array of spring-loaded switches is disposed on the latitudinal top surface and is arranged in a plurality of parallel rows and a plurality of parallel columns. The array has an arrangement of spring-loaded switches that spatially correspond to an array of guitar fret-guitar string intersections on a guitar fingerboard. Each of the spring-loaded switches corresponds to a different guitar fret-guitar string intersection. A musical instrument digital interface processor receives input from each of the spring-loaded switches and that generates a digital message output when a selected switch of the array is depressed so that the digital message output corresponds to a note associated with the selected switch. A structure is configured to support the frame so that the latitudinal top surface is maintained at a substantially horizontal attitude.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top view of one embodiment of a musical instrument input device.

FIG. 2 is a top view of an embodiment configured as a keyboard.

FIG. 3 is a perspective view of the embodiment shown in FIG. 2.

FIG. 4 is a front plan view of one embodiment.

FIG. 5 is a block diagram of a digital keyboard embodiment.

FIG. 6 is a schematic diagram of the digital keyboard embodiment shown in FIG. 5.

FIG. 7 is a photograph of a keyboard embodiment.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

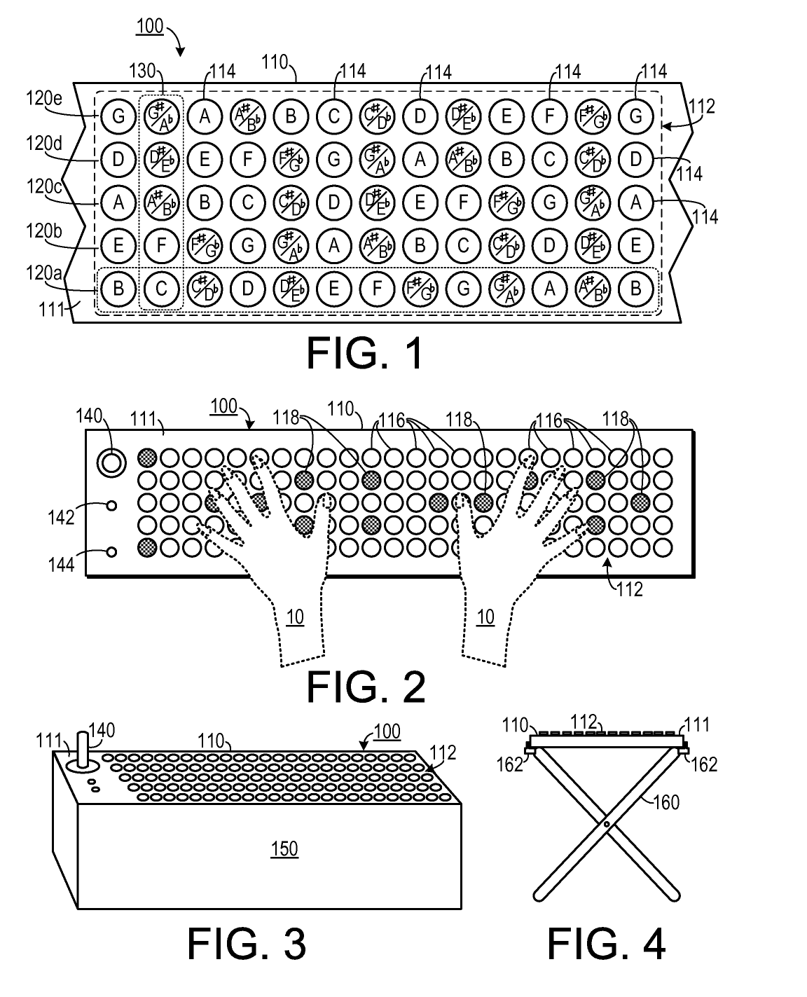

As shown in FIGS. 1-2, one embodiment is a musical instrument keyboard device 100 that includes a frame 110 that has a latitudinal top surface 111. An array 112 of equally sized and spaced apart keys 114 is mounted onto the latitudinal top surface 110. Each of the keys 114 corresponds to a note on a chromatic scale. (In FIG. 1, the letters naming the notes (e.g., A, B, C, C#, etc.) corresponding to the keys 114 are shown superimposed on the keys. However, many commercial embodiments would not include such letters on the keys 114.) The keys 114 are arranged in a plurality of rows 120a-e and a plurality of columns 130 and the keys 120 in each row are arranged to correspond to a chromatic scale. (While five rows 120a-e are shown in the figures, it should be understood that any number of at least two rows may be employed without departing from the scope of the invention. Similarly, more than thirteen columns may be employed.)

While each row 120a-e includes a plurality of keys 114 corresponding to a chromatic scale, each successive row includes keys 114 that form a transposition by a predetermined interval of the row immediately adjacent to it. For example, row 120a includes keys 114 that form a scale with the notes B-C-C#-D-D#-E-F-F#-G-G#-A-A#, whereas row 120b includes keys 114 that form a scale that is a transposition of the scale in row 120a by five musical half-steps (resulting in the following arrangement of notes: E-F-F#-G-G#-A-A#-B-C-C#-D-D#). However, to play the transposed scale, the musician need only shift his fingers up one row (from row 120a to 120b) while maintaining the same finger positions relative to row 120a.

Additional controls and indicators may also be disposed on the frame 110. For example, a note bending controller 140 (such as a joy stick) may be added, as well a volume control knob 142. Additional controls could be added and used to modify sounds (e.g., add vibration, reverberation, etc.). An indicator light 144 may also be used to show if the system is powered on. As is clearly understood in the art, many additional switches, controllers and indicators may be added without departing from the scope of the invention.

As shown in FIG. 2, selected ones of the keys may be color coded to provide a user with an indication of the notes corresponding to the keys. In the example given, most of the keys are white keys 116, but some of them are color coded black keys 118. The pattern of the color coded keys 118 assists the musician in playing the instrument. The arrangement and position of the keyboard allows the musician to play the keyboard with both hands from above the keyboard, like a traditional piano keyboard. In the example shown in FIG. 2, the keys are arranged to correspond to the guitar fret-guitar string intersections found on a 5-string guitar fingerboard. This arrangement allows a guitarist to play a keyboard without having to learn the note arrangement of, for example, a piano keyboard.

As shown in FIG. 3, the frame 110 is supported by a structure that is configured to support the frame 110 in a position conducive to play. In most applications, the top surface 111 is maintained in a substantially horizontal position. (As used herein, “a substantially horizontal position” includes any position that corresponds to normal play of a piano-type keyboard, in which the hands are placed above the keyboard. It should be recognized that keyboard players sometimes tilt the keyboard slightly according to a personal preference. It is understood that when a keyboard is in “a substantially horizontal position” it might be tilted slightly according to the musician's preference.) In the embodiment shown, the structure can include a rectangular box 150. As shown in FIG. 4, other support structures may also be employed, such as a collapsible stand 160 of the type typically employed with existing electronic keyboards. In such an embodiment, an attachment structure 162 (e.g., a clamp) may be used to affix the frame 110 to the collapsible stand 160.

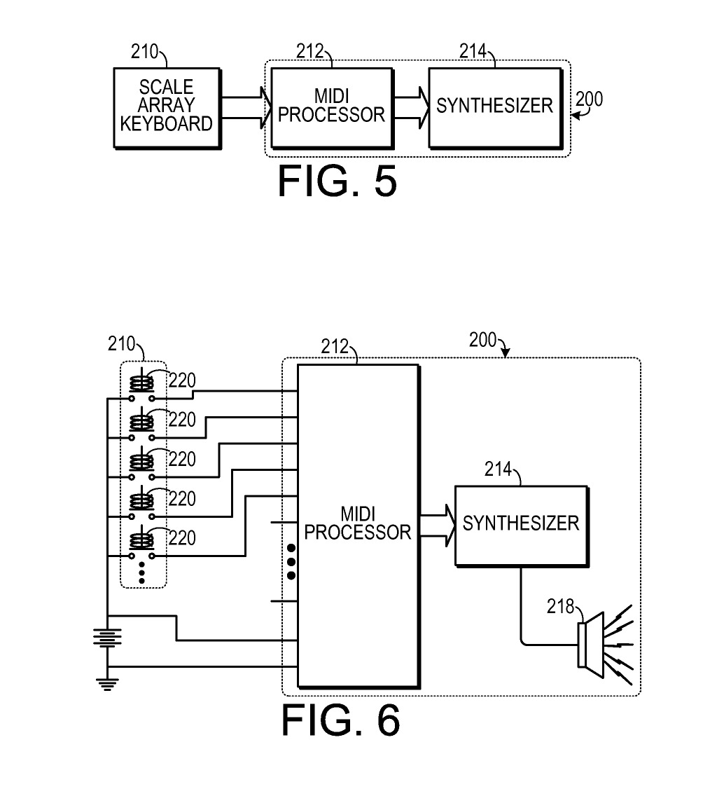

A note generator generates a sound corresponding to a note associated with a selected key when the selected key is activated (e.g., when the key is depressed). For example, as shown in FIGS. 4-5, in an electronic keyboard embodiment, a keyboard 210 could include a plurality of spring loaded switches 220 that are each coupled to a different key on the keyboard so that when a key is depressed, the corresponding switch 220 is closed, or in an “on” state. The switches 220 are coupled to a note generator 200.

The note generator 200, in one embodiment includes a musical instrument digital interface (MIDI) processor 212 that is coupled to a synthesizer 214. The MIDI processor 212 generates a digital message onto a digital message output of a musical instrument digital interface when a selected switch 220 is depressed so that the digital message corresponds to a note associated with the selected switch. The synthesizer 214 then decodes the digital message and generates an electronic signal corresponding to the note. The electronic signal is then used to drive a speaker 218, which produces a sound corresponding.

As would be well understood in the art of electronic musical instrument design, the note generator could also include an analog sound generating circuit that generates an electronic signal corresponding to a selected sound when a key is activated. An amplifier would amplify the electronic signal and a speaker would transform the electronic signal into a sound.

Similarly, the note generator could include an acoustic sound generating mechanism. For example, in a xylophone configuration, each key could be embodied as a metal plate so that the metal plates are arranged according to the relationship shown in FIG. 1. In such an embodiment, the key would be activated by striking it. Thus, the invention could be applied in a vibraphone embodiment, a xylophone embodiment, a marimba embodiment or similar devices.

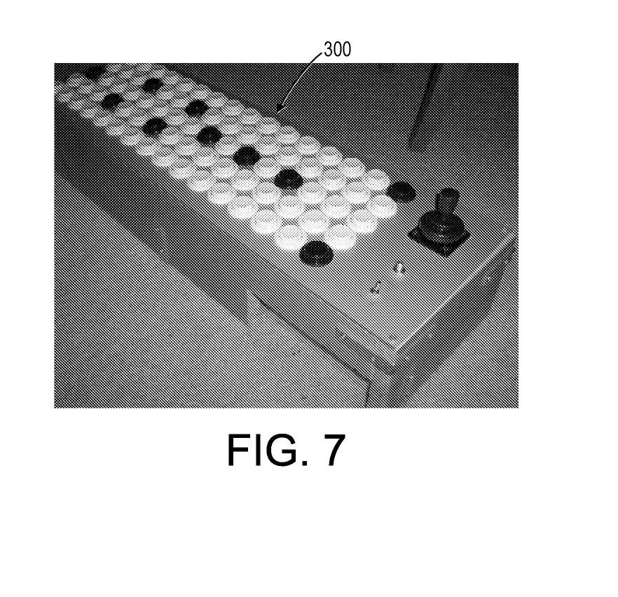

A photograph of one embodiment of a keyboard 300 according to the invention is shown in FIG. 7. In this embodiment, arcade game buttons were used as the keys.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A musical instrument keyboard device, comprising:
a. a frame that includes a latitudinal top surface;
b. an array of equally sized and spaced apart keys mounted onto the latitudinal top surface, each of the keys corresponding to a note on a chromatic scale and each of the keys arranged in a plurality of rows and a plurality of columns, wherein the keys in each row are arranged to correspond to a chromatic scale and wherein the keys in any selected row are in a scalar transposition by a predetermined interval relative to each row adjacent to the selected row, so that each key in a column corresponds to a note that is shifted from a note corresponding to an immediately adjacent key in the column by the predetermined interval; and
c. a note generator that generates a sound corresponding to a note associated with a selected key when the selected key is activated.

2. The musical instrument keyboard device of claim 1, wherein each of the keys comprises a spring loaded switch and wherein the note generator comprises a musical instrument digital interface processor that receives input from each of the spring-loaded switches and that generates a digital message onto a digital message output of a musical instrument digital interface when a selected switch of the array is depressed so that the digital message corresponds to a note associated with the selected switch.

3. The musical instrument keyboard device of claim 2, further comprising a synthesizer that generates a sound corresponding to the note associated with the selected switch when the selected switch is in an “on” state.

4. The musical instrument keyboard device of claim 1, wherein the note generator comprises:
a. an analog sound generating circuit that generates an electronic signal corresponding to a selected sound when a key is activated;
b. an amplifier that amplifies the electronic signal; and
c. a speaker that transforms the electronic signal into a sound.

5. The musical instrument keyboard device of claim 1, wherein the note generator comprises an acoustic sound generating mechanism.

6. The musical instrument keyboard device of claim 1, further comprising a structure configured to support the frame so as to maintain the latitudinal top surface in a substantially horizontal position.

7. The musical instrument keyboard device of claim 6, wherein the structure comprises a rectangular box.

8. The musical instrument keyboard device of claim 6, wherein the structure comprises a collapsible stand that includes an attachment that is configured to affix the frame to the collapsible stand.

9. The musical instrument keyboard device of claim 1, wherein selected ones of the keys are color coded to provide a user with an indication of the notes corresponding to the keys.

10. An electronic musical instrument, comprising:
a. a frame that includes a latitudinal top surface;
b. an array of equally sized and spaced apart keys mounted onto the latitudinal top surface, each of the keys corresponding to a note on a chromatic scale and each of the keys arranged in a plurality of rows and a plurality of columns, wherein the keys in each row are arranged to correspond to a chromatic scale and wherein the keys in any selected row are in a scalar transposition by a predetermined interval relative to each row adjacent to the selected row, so that each key in a column corresponds to a note that is shifted from a note corresponding to an immediately adjacent key in the column by the predetermined interval;
c. a plurality of spring-loaded switches in which each switch is coupled to a different key of the array of equally sized and spaced apart keys;
d. a musical instrument digital interface processor that receives input from each of the spring-loaded switches and that generates a digital message onto a digital message output of a musical instrument digital interface when a selected switch of the array is depressed so that the digital message corresponds to a note associated with the selected switch; and
e. a sound generating system, coupled to the digital message output, that generates a sound corresponding to a digital message received from the musical instrument digital interface processor.

11. The electronic musical instrument of claim 10, further comprising a synthesizer that generates a sound corresponding to the note associated with the selected switch when the selected switch is in an “on” state.

12. The electronic musical instrument of claim 10, further comprising a structure configured to support the frame so as to maintain the latitudinal top surface in a substantially horizontal position.

13. The electronic musical instrument of claim 12, wherein the structure comprises a rectangular box.

14. The electronic musical instrument of claim 12, wherein the structure comprises a collapsible stand that includes an attachment that is configured to affix the frame to the collapsible stand.

15. The electronic musical instrument of claim 10, wherein selected ones of the keys are color coded to provide a user with an indication of the notes corresponding to the keys.

16. An electronic musical keyboard, comprising:
a. a frame that includes a latitudinal top surface;
b. an array of spring-loaded switches, disposed on the latitudinal top surface, arranged in a plurality of parallel rows and a plurality of parallel columns so that the array has an arrangement of spring-loaded switches that spatially correspond to an array of guitar fret-guitar string intersections on a guitar fingerboard, wherein each of the spring-loaded switches corresponds to a different guitar fret-guitar string intersection;
c. a musical instrument digital interface processor that receives input from each of the spring-loaded switches and that generates a digital message output of a musical instrument digital interface when a selected switch of the array is depressed so that the digital message output corresponds to a note associated with the selected switch; and
d. a structure that is configured to support the frame so that the latitudinal top surface is maintained at a substantially horizontal attitude.

17. The electronic musical keyboard of claim 16, wherein the structure comprises a rectangular box.

18. The electronic musical keyboard of claim 16, wherein the structure comprises a collapsible stand that includes an attachment that is configured to affix the frame to the collapsible stand.

19. The musical keyboard of claim 16, further comprising a synthesizer that generates a sound corresponding to the note associated with the selected switch when the selected switch is in an “on” state.

20. The musical keyboard of claim 16, wherein selected ones of the keys are color coded to provide a user with an indication of the notes corresponding to the keys.
